(19) United States
(12) Patent Application Publication
(10) Pub. No.: US 2026/0009949 A1
(43) Pub. Date: Jan. 8, 2026

(54) In-situ polarization extinction ratio monitoring

(71) Applicant: Ciena Corporation, Hanover, MD (US)

(72) Inventors: Will Leckie, Ottawa (CA); Yves Beaulieu, Nepean (CA); Michael Vitic, Chelsea (CA); Marie-Josee Picard, L’Ancienne-Lorette (CA); Matthew Pippo, Ottawa (CA); Sacha Corbeil, Kanata (CA)

(73) Assignee: Ciena Corporation, Hanover, MD (US)

(21) Appl. No.: 18/761,837

(22) Filed: Jul. 2, 2024

(51) Int. Cl. G02B 6/27; G02B 6/126

(52) U.S. Cl. CPC G02B 6/2766; G02B 6/126; G02B 6/2773

(57) ABSTRACT

In-situ Polarization Extinction Ratio (PER) monitoring in a photonic device, such as a Silicon Photonics (SiP) chip, Photonic Integrated Circuit (PIC), and the like is disclosed. The photonic device includes a PIC; and a laser connected to an input of the PIC via Polarization-maintaining (PM) devices; wherein the PM device has a desired polarization axis on a first mode and undesired on a second undesired mode, and wherein the PIC includes an on-chip first monitoring photodiode and circuitry configured to determine Polarization Extinction Ratio (PER) based on an optical power measured by the on-chip first monitoring photodiode.

### FIELD OF THE DISCLOSURE

The present disclosure relates generally to fiber optics. More particularly, the present disclosure relates to systems and methods for in-situ Polarization Extinction Ratio (PER) monitoring in a photonic device, such as a Silicon Photonics (SiP) chip, Photonic Integrated Circuit (PIC), and the like.

### BACKGROUND OF THE DISCLOSURE

Polarization Extinction Ratio (PER) is a measure of angular misalignment at an interface between two Polarization-maintaining (PM) optical devices, such as two PM optical fibers, or a PM fiber attachment to an optical device such as a Photonic Integrated Circuit (PIC). For example, some optical modem products include a laser that is fiber-coupled to an optical transmitter and/or receiver function within a PIC via a fusion splice or any other forms of optical coupling. PER is defined as the ratio of the power of light in the desired polarization state to the power of light in the orthogonal (undesired) polarization state. A high PER indicates that a device effectively maintains the desired polarization state, with minimal power in the orthogonal state, which is crucial for applications requiring high polarization purity, such as in optical communication systems, sensors, and various other photonic applications. Conventionally, external test equipment is used to measure PER, such as by applying controlled temperature- and/or wavelength- and/or mechanical stress excursions and monitoring the detected optical power at the output of a polarization analyzer (a polarization-diverse element such as a polarization splitter with photodiodes at the outputs). Such test equipment operates by a direct synchronous measure of optical power detected by the polarization analyzer of both the desired- and off-axis polarization modes. Disadvantageously, external test equipment is not practical, cost-effective, space- or power-efficient for use in some photonic devices.

### BRIEF SUMMARY OF THE DISCLOSURE

The present disclosure relates to systems and methods for in-situ Polarization Extinction Ratio (PER) monitoring in a photonic device. Variously, the present disclosure includes different techniques for in-situ PER monitoring where “in-situ” refers to processes, measurements, or operations that are performed directly within the device. In an embodiment, the in-situ detection of imperfect PER is via in-situ/in-service monitoring of Transverse Magnetic (TM) mode power within a PIC, and, in another embodiment, the simultaneous monitoring of both Transverse Electric (TE) and TM mode power allows comparison of TE and TM mode powers and a direct in-situ measurement of PER. In a further embodiment, the in-situ detection of imperfect PER is via in-situ monitoring of the behavior of a transmitter's optical power feedback control mechanisms in response to periodic beating of desired- and off-axis light.

Practical applications include
(1) A factory screening test that can be performed via controlled temperature- and/or wavelength-excursions and/or a broadband source while monitoring the on-chip TM mode power to detect the presence of finite PER within the PIC;
(2) A factory screening test that can be performed via controlled temperature- and/or wavelength-excursions and/or a broadband source with simultaneous monitoring of the on-chip TE and TM mode powers to directly measure the finite PER within the PIC;
(3) Similarly, a field provisioning self-test;
(4) Similarly, in-service, in-situ monitoring; and
(5) In-service, in-situ monitoring of ambient temperature changes and the corresponding behavior of the transmitter optical power control loops.

In an embodiment, a photonic device includes a Photonic Integrated Circuit (PIC); and a laser connected to an input of the PIC via a Polarization-maintaining (PM) device; wherein the PM device has a desired polarization axis on a first mode and undesired on a second undesired mode, and wherein the PIC includes an on-chip first monitoring photodiode and circuitry configured to determine Polarization Extinction Ratio (PER) based on an optical power measured by the on-chip first monitoring photodiode.

The on-chip first monitoring photodiode can measure second undesired mode optical power and the PER is inferred based on the second undesired mode optical power. The photonic device can include a polarization splitter connected to the input, wherein the first mode is connected to a first output of the polarization splitter and the first monitoring photodiode is connected to a second output of the polarization splitter. The photonic device can include a second monitoring photodiode connected to the first output configured to monitor first mode optical power, wherein the PER is determined based on a comparison of the second undesired mode optical power and the first mode optical power. The photonic device can include a Spot Size Converter (SSC) between the input and the polarization combiner and rotator. The PER can be determined by the first monitoring photodiode via a direct measurement of the second undesired mode in steady-state condition.

The PIC can include at least one power control actuator, the on-chip first monitoring photodiode measures the optical power after the at least one power control actuator, and the at least one power control actuator is controlled based on the optical power. The PER can be determined by the circuitry in a presence of a change in temperature, wavelength, and/or mechanical strain by monitoring a control response of the at least one power control actuator.

The circuitry configured to determine the PER can be further configured to determine optical power fluctuations during temperature ramps, and determine the PER based on an amplitude and period of the optical power fluctuations. The photonic device can be an optical modem. The PM device can be PM fiber. The first mode can be a Transverse Electric (TE) mode and the second undesired mode can be a Transverse Magnetic (TM) mode.

In another embodiment, a method includes steps of, responsive to a laser being connected to an input of a Photonic Integrated Circuit (PIC) via a Polarization-maintaining (PM) device having a desired polarization axis on a first mode and undesired on a second undesired mode, monitoring optical power by an on-chip first monitoring photodiode; and determining Polarization Extinction Ratio (PER) based on the monitored optical power.

The on-chip first monitoring photodiode can measure second undesired mode optical power and the PER is inferred based on the second undesired mode optical power. The method can include steps of performing polarization combining and rotation at the input via a polarization splitter, wherein the first mode is connected to a first output of the polarization splitter and the first monitoring photodiode is connected to a second output of the polarization splitter. The method can include steps of measuring first mode optical power via a second monitoring photodiode connected to the first output, wherein the PER is determined based on a comparison of the first mode optical power and the second undesired mode optical power.

The PER can be determined by the first monitoring photodiode via a direct measurement of the second undesired mode in steady-state condition. The PER can be determined by the first monitoring photodiode in a presence of a change in temperature, wavelength, and/or mechanical strain by monitoring a control response of power control actuators.

The method can be performed in an optical modem. The PIC can include at least one power control actuator, the on-chip first monitoring photodiode performs the monitoring the optical power after the at least one power control actuator, and wherein the method can further include controlling the at least one power control actuator based on the optical power.

### BRIEF DESCRIPTION OF THE DRAWINGS

The present disclosure is detailed through various drawings, where like components or steps are indicated by identical reference numbers for clarity and consistency.

FIG. 1 illustrates a Polarization-maintaining (PM) fiber.

FIG. 2 illustrates the PM fiber and finite PER at a PM fiber splice.

FIG. 3 illustrates finite PER at the attachment of the PM fiber or ferrule to a Photonic Integrated Circuit (PIC).

FIGS. 4-6 illustrate a photonic device including in-situ PER measurement.

FIG. 7 illustrates graphs of optical power and temperature over time showing finite splice PER resulting in optical beating during temperature cycle.

FIG. 8 illustrates a photonic device configured for in-situ PER measurement based on optical beating during temperature cycle.

FIG. 9 illustrates graphs of optical power control loop response to optical beating during temperature cycle.

FIG. 10 illustrates a flowchart of a process for in-situ PER measurement.

### DETAILED DESCRIPTION OF THE DISCLOSURE

The present disclosure relates to systems and methods for in-situ Polarization Extinction Ratio (PER) monitoring in a photonic device.

### Polarization-Maintaining (PM) Fiber

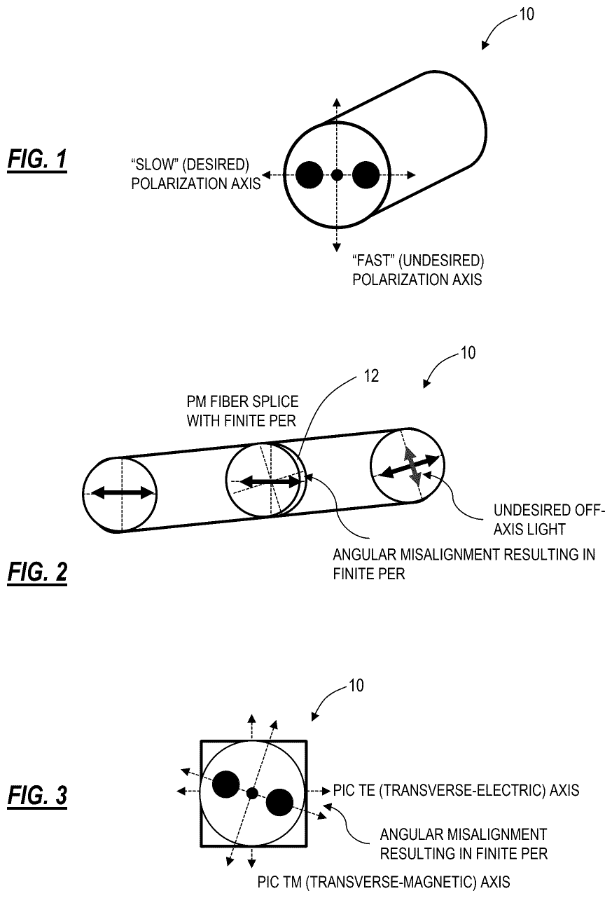

FIG. 1 illustrates a Polarization-maintaining (PM) fiber 10 which is a specialized type of optical fiber designed to preserve the polarization state of light as it propagates through the fiber. Unlike standard single-mode fibers, which do not control the polarization state and can allow it to fluctuate due to external stresses or fiber imperfections, PM fibers 10 have a built-in asymmetry, typically created by stress rods or an elliptical core, that maintains a fixed relationship between the axes of polarization. In a PM fiber 10, the slow and fast axes refer to the two orthogonal polarization modes that propagate at different speeds through the fiber. This unique structure ensures that light entering the fiber with a specific polarization state retains that state throughout its transmission, making PM fibers 10 crucial for applications requiring high polarization stability, such as in interferometry, fiber optic sensing, and quantum key distribution. The preservation of the polarization state is quantified by the Polarization Extinction Ratio (PER), a critical performance metric for PM fibers 10.

FIG. 2 illustrates the PM fiber 10 and finite PER at a PM fiber splice 12 which occurs due to misalignment of the slow and fast axes, splice quality, intrinsic differences between the fibers, environmental factors, and the like. Perfectly aligning the polarization axes of the spliced fibers is challenging, and any misalignment causes light to couple into the orthogonal polarization mode, reducing PER. Additionally, imperfections at the splice joint and variations in fiber properties can degrade PER. Environmental conditions such as temperature changes and mechanical stress further influence the alignment and coupling characteristics, resulting in a finite PER at the PM fiber splice 12.

FIG. 3 illustrates finite PER at the attachment of the PM fiber 10 or ferrule to a Photonic Integrated Circuit (PIC) which arises from several alignment and interface challenges. Precise alignment of the PM fiber's slow and fast axes with the corresponding polarization-maintaining structures on the PIC is critical. Any misalignment at this interface causes coupling of light into unintended polarization modes, reducing the PER. Additionally, imperfections at the attachment point, such as surface roughness, air gaps, or bonding inconsistencies, further degrade the PER by scattering or mode mixing. Environmental factors, such as temperature fluctuations and mechanical stress, can also impact the alignment and stability of the polarization state, resulting in a finite PER at the PM fiber/PIC interface.

In these cases, namely PM fiber splices and attachment of PM fiber to a PIC, a finite PER is problematic because it indicates incomplete maintenance of the desired polarization state, leading to several issues in photonic systems. It causes signal degradation and increased bit error rates in optical communication systems, introduces interference and noise in interferometric sensors, reduces the efficiency of modulators and switches, and causes cross-talk in multiplexed systems. Additionally, environmental factors can further degrade PER over time, leading to inconsistent performance and the need for frequent recalibration. These issues collectively undermine the reliability and precision of photonic devices and systems that rely on accurate polarization control.

### Conventional PER Measurement

The use of test equipment-based polarization analyzer to directly measure PER is suitable for lab applications, but is not practical, cost-effective, space- or power-efficient for use within an optical modem product or the like. Furthermore, the use of a polarization analyzer based PER measurement equipment within a production test environment to characterize every PM splice is not practical or efficient, especially with the very short fiber lengths typical of pluggable optical modules. Moreover, a PIC itself naturally partially filters out the undesirable TM mode polarization state on-chip, making it impossible to detect off-axis TM mode power at the PIC output. As a result, the loss induced by the angular PM fiber alignment uncertainty at the PIC input is contained within the overall PIC insertion loss and the contribution of finite PIC input PER alone cannot be isolated from the overall PIC insertion loss.

Finite PER during assembly and/or manufacturing of photonic devices is unavoidable, and undesirable. Optical modems continue to be designed into smaller and more demanding mechanical form factors, using fiber with shorter lengths, smaller diameter, and tighter bend radius, which makes PM fiber splicing and fiber routing more challenging. Direct measurement of PER of every splice in production using commercial test equipment is impractical time-wise and capital-demanding. In the best case, undetected poor splice PER results in wasted optical power, and, in the worst case, it results in reduced factory yield, difficult-to-detect performance degradations due to reduced operating margin of optical power control loops, and the potential for latent splice reliability issues.

There is a need for in-situ PER measurement to address these concerns.

### TM-Based In-Situ PER Measurement

In an embodiment, the present disclosure includes a cost-effective in-situ PER measurement via monitoring of a TM mode photodetector (PD) within a PIC. This can be used to detect poor splice PER, and used to implement a factory screening test and/or in-situ monitoring in the field, requiring only the monitoring/analysis of the off-axis TM mode power, optionally augmented by a ratiometric comparison to monitoring of the TE mode power and/or PIC power control actuator response. “Ratiometric” refers to a measurement technique or system that derives its output by comparing or taking the ratio of two quantities.

The analysis can be refined in the presence of a controlled or uncontrolled temperature- and/or wavelength ramp which excites periodic beating between TE and TM mode powers at the input to the chip. Such temperature cycle testing can be performed on optical modem products during manufacturing, and this testing can be augmented with monitoring/analysis of the on-chip PD(s) to directly measure splice PER at the PIC input. Numerical pass/fail limits can be established to maximize factory test yield to a PER that is acceptable within the product application/specifications. Alternatively, a broadband source could be used instead of a laser to capture at once the average power loss induced by a poor splice PER. In-situ monitoring of ambient temperature changes and the corresponding response of the TM mode PD can also be implemented in optical modem product firmware/software to monitor, analyze, and directly measure finite PER during field service.

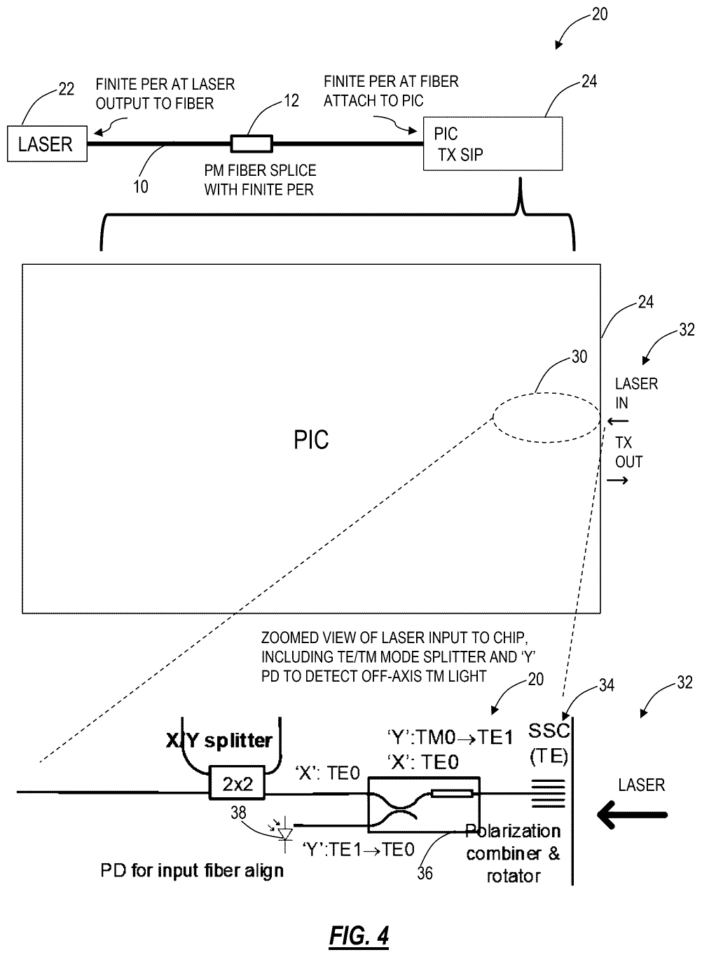

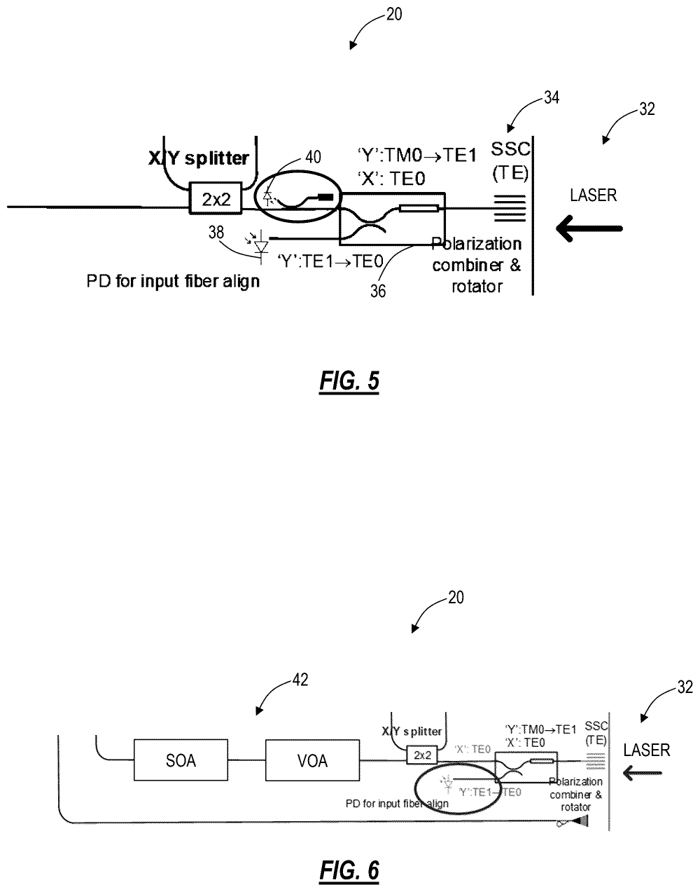

FIGS. 4-6 illustrate a photonic device 20 including in-situ PER measurement. In an embodiment, the photonic device 20 is an optical modem including a laser or broadband source 22 connected to a PIC 24 via PM fiber 10 having a PM fiber splice 12, thereby having finite PER. The PIC 24 includes an in-situ PER measurement circuit 30 at an input 32, e.g., a laser or other broadband source input to the PIC 24. For example, the laser or other broadband source can be connected to the input 32 as well as coupled to the input, e.g., free-space via lenses, and the like. The PIC 24 includes a Spot Size Converter (SSC) 34, an on-chip polarization rotation function 36, a photodiode 38 to monitor TM mode power, and supporting circuitry to allow in-situ monitoring of the TM mode power in the product application. The polarization rotation function 36 changes the polarization state of light as it propagates through, specifically ensuring a desired first mode (e.g., X, TE0 in this example) outputs on one output, and the undesired second mode (e.g., Y, TE1 or TM in this example) outputs on a separate output connected to the photodiode 38. In FIG. 5, an optional inline TE mode photodiode 40 allows direct simultaneous measurement of TE and TM mode powers and therefore the direct measurement of on-chip PER. In FIG. 6, a further optional implementation compares the TM mode PD response to the response of downstream PIC optical functions 42 (e.g., Variable Optical Attenuator (VOA), Semiconductor Optical Amplifier (SOA), etc.) as an indirect measurement of on-chip PER.

In FIG. 4, the PIC 24 includes the photodiode 38 which is an on-chip TM mode monitoring photodiode (PD) to detect the presence of undesired TM mode light at the PIC input 32, with supporting circuitry enabling in-situ/in-service monitoring. That is, because the input 32 is from PM fiber 10, it should only have light on one axis, the TE0 mode axis and any light on the TM mode axis is undesired and detected by the photodiode 38. In this embodiment, the finite PER can be inferred by measurement of the optical power in the TM mode axis at the input to the PIC.

In FIG. 5, the PIC 24 also includes the TE photodiode 40, supporting simultaneous measurement of TE and TM mode powers. In this embodiment, the actual PER can be directly computed by simultaneous measurement of both the TM and TE mode powers while exciting a periodic beating of desired- and off-axis light in the fiber via any combination of temperature change, optical wavelength change, or mechanical stress.

In FIG. 6, a further extension includes ratiometric comparison of the TM mode PD monitor to the control response of downstream PIC power control actuators such as SOA/VOA as an indirect in-situ measurement of the PER at the PIC input. Here, the
(1) TM photodiode 38 monitors off-axis TM power at the PIC input 32.
(2) PIC power control (SOA, VOA, etc.) actuator responds to changes in TE mode input power.
(3) Ratio of power control response to TM mode power monitor allows estimation of finite PER at PIC input.

This approach includes a direct measurement of the off-axis TM mode light, and optionally the TE mode light as well. As a result, the approach allows direct measurement of off-axis TM mode light in steady-state conditions, even in the absence of a change in temperature and/or wavelength and/or mechanical strain on the fiber to excite periodic beating between TE and TM mode light. The precision of the approach is then further improved in the presence of a change in temperature and/or wavelength and/or mechanical strain on the fiber to excite periodic beating between TE and TM mode light.

Of note, the foregoing description was based on an example embodiment where the desired mode is the TE mode and the second, undesired mode is the TM mode. In another embodiment, it is possible to turn the input laser polarization from TE (horizontal) to TM (vertical) before entering the SiP chip. In this special case, the “Main or first mode” would be TM and the “second undesired mode” would be TE. This case is also contemplated herein.

### In-Situ PER Measurement Based on Optical Beating During Temperature Cycle

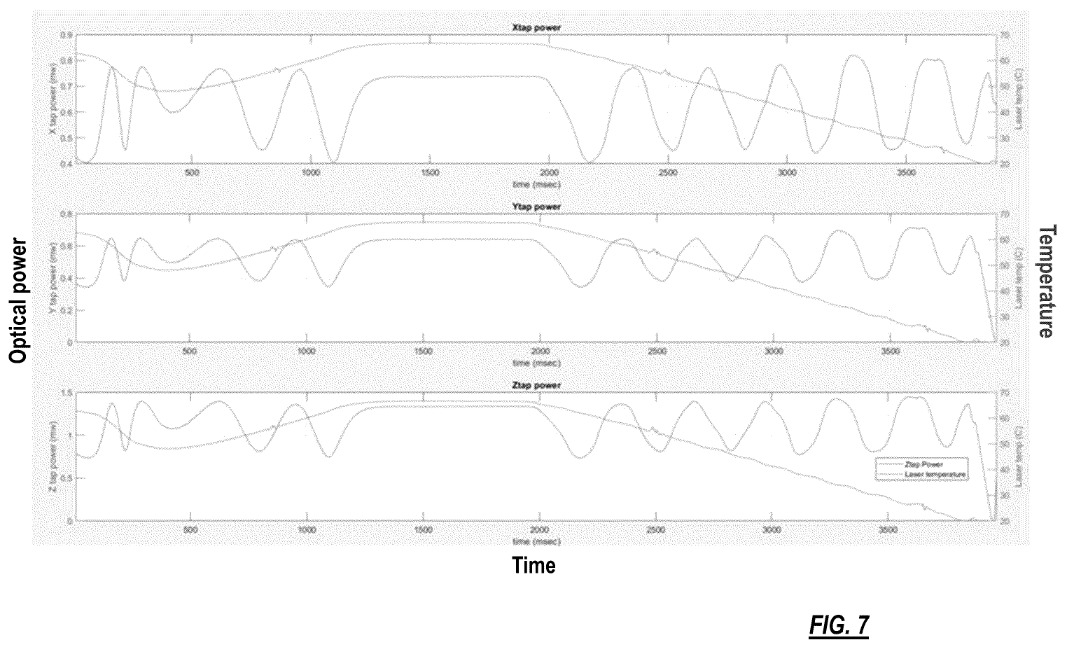

FIG. 7 illustrates graphs of optical power and temperature over time showing finite splice PER resulting in optical beating during temperature cycle. Optical modem transmitters use some form of feedback control of optical power at the output of, or downstream of the output of, the optical modulator. The feedback loop is closed from a measurement of modulated optical power downstream of the modulator, feeding back to an optical power adjustment mechanism such as an RF drive level control and/or optical loss (VOA) or gain (amplification) mechanism. There are periodic optical power fluctuations (“beating”) during temperature ramps. The amplitude of beating depends on splice PER, and the period of beating depends on fiber length. As a Rule of thumb: 1 m of Panda PM fiber will undergo a full 2pi cycle over a 4 degree C. temperature change.

Compared to the TM mode approach above, this approach does not directly measure off-axis TM mode power on the PIC, it relies on assumptions about the PM fiber length between splice and PIC, and prior knowledge/calibration of optical power control loop response, to infer the presence of such off-axis TM mode power.

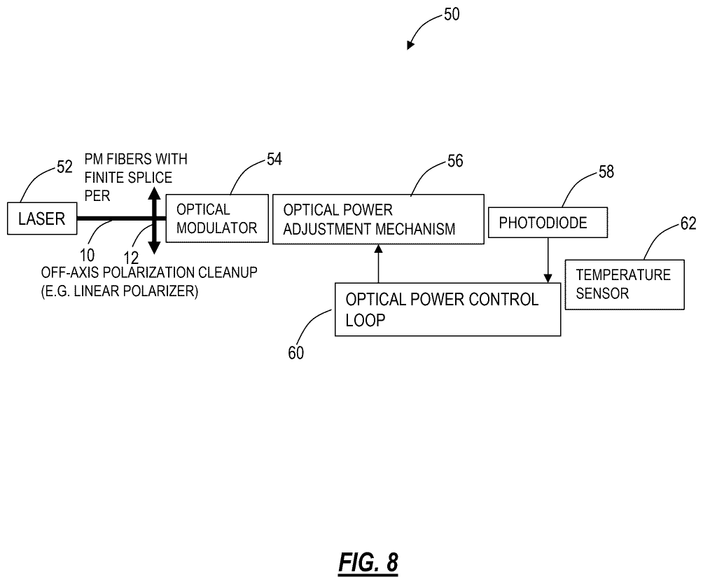

FIG. 8 illustrates a photonic device 50 configured for in-situ PER measurement based on optical beating during temperature cycle. The photonic device 50 can be similar to the photonic device 20, e.g., a modem. The photonic device 50 includes a laser 52 connected to an optical modulator 54 via the PM fiber 10 and the PM fiber splice 12. The modulator 54 can be a PIC as in the PIC 24. The optical modulator 54 includes a linear polarizing element. The photonic device 50 includes an optical power adjustment mechanism 56, a photodiode 58, an optical power control loop 60 between the photodiode 58 and the optical power adjustment mechanism 56, and a temperature sensor 62. The optical power adjustment mechanism 56 may include an EDFA, SOA and/or a VOA, for example. The optical power control loop 60 is closed-loop optical power control with feedback from photodiode(s) to RF and/or optical gain or loss elements such as an RF driver, VOA, EDFA, etc.

In this embodiment, the photonic device 50 involves the monitoring of the feedback control response of the optical power adjustment mechanism 56 within an optical transmitter to detect the presence of imperfect PER via the periodic beating of desired- and off-axis light. This provides measurement of imperfect PER via in-situ monitoring of the behavior of a transmitter's optical power feedback control mechanisms 56 in response to periodic beating of desired- and off-axis light. Since temperature and/or wavelength excursions result in a periodic beating of the desired- and off-axis polarization components at the linear polarizer, such excursions result in periodic fluctuations in the feedback response of the downstream optical power control loop.

The amplitude of the optical beating depends on the PM splice PER whereas the period of the optical beating depends on the fiber length. As a rule of thumb, 1 meter of Panda PM fiber will undergo a full 2pi phase change cycle over a 4 degree C. temperature change, which results in one full cycle of optical power beating between desired- and off-axis light. If the ramp rate and relative change in temperature- and/or wavelength are known or calibrated, and if the control response of the optical power control mechanism is known or calibrated, then such periodic fluctuations in optical power control loop behavior can be monitored and analyzed to infer the finite PER within the transmitter.

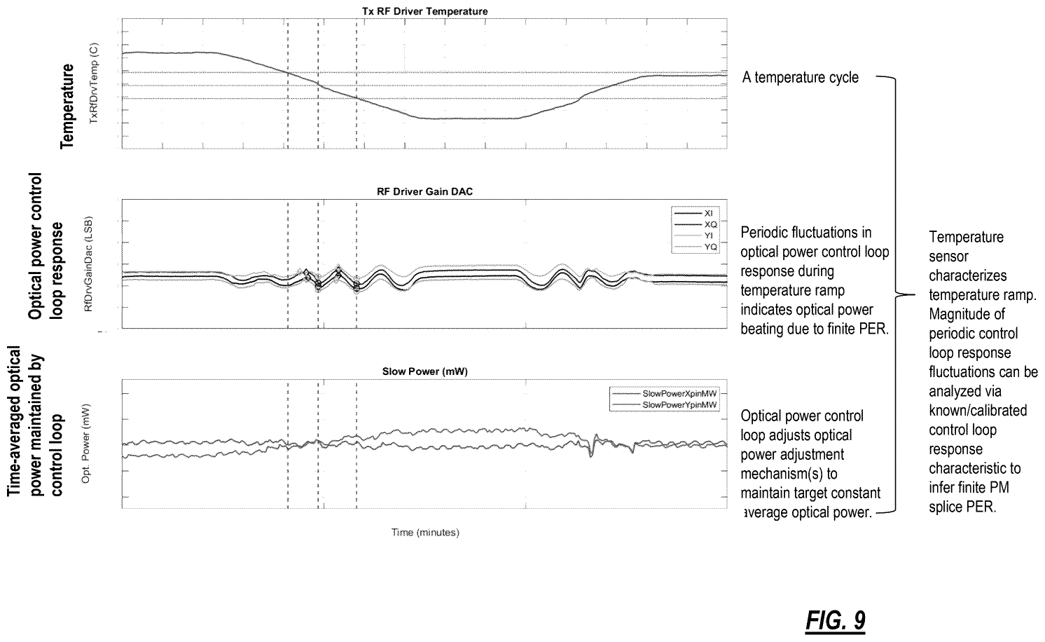

FIG. 9 illustrates graphs of optical power control loop response to optical beating during temperature cycle. A first graph illustrates temperature, namely a temperature cycle. A second graph illustrates optical power control loop response showing periodic fluctuations in optical power control loop response during temperature ramp indicates optical power beating due to finite PER. A third graph illustrates time-averaged optical power maintained by control loop. Here, the optical power control loop adjusts optical power adjustment mechanism(s) to maintain target constant average optical power. The temperature sensor 62 characterizes temperature ramp. Magnitude of periodic control loop response fluctuations can be analyzed via known/calibrated control loop response characteristic to infer finite PM splice PER.

### Process for In-Situ PER Measurement

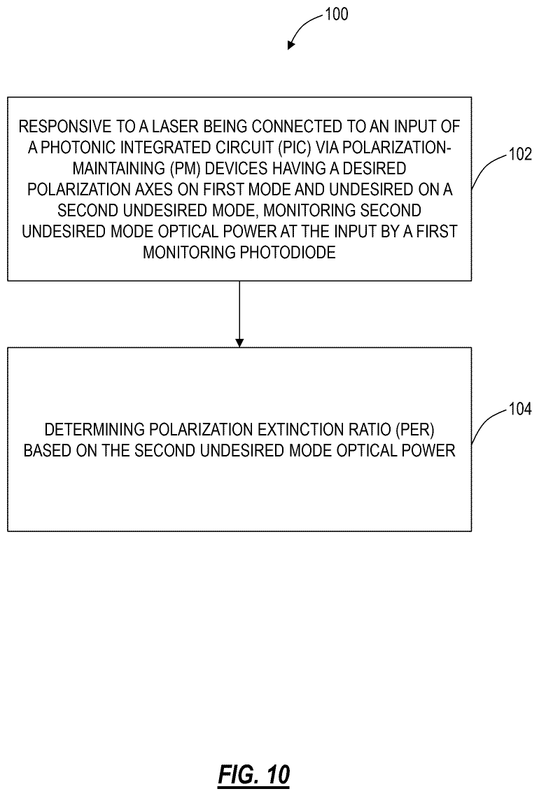

FIG. 10 illustrates a flowchart of a process 100 for in-situ PER measurement. The process 100 includes, responsive to a laser being connected to an input of a Photonic Integrated Circuit (PIC) via Polarization-maintaining (PM) devices having a desired polarization axis on a first mode and undesired on a second undesired mode, monitoring optical power by an on-chip first monitoring photodiode 38, 58 (step 102); and determining Polarization Extinction Ratio (PER) based on the monitored optical power (step 104).

The on-chip first monitoring photodiode can measure second undesired mode optical power and the PER is inferred based on the second undesired mode optical power. The process 100 can include performing polarization combining and rotation at the input via a polarization splitter, wherein the first mode is connected to a first output of the polarization splitter and the first monitoring photodiode is connected to a second output of the polarization splitter The process 100 can include measuring first mode optical power via a second monitoring photodiode connected to the first output, wherein the PER is determined based on a comparison of the first mode optical power and the second undesired mode optical power.

The PER can be determined by the first monitoring photodiode via a direct measurement of the second undesired mode in steady-state condition. The PER can be determined by the first monitoring photodiode in a presence of a change in temperature, wavelength, and/or mechanical strain by monitoring a control response of power control actuators. The process 100 is performed in an optical modem. The PIC can include at least one power control actuator, the on-chip first monitoring photodiode performs the monitoring the optical power after the at least one power control actuator, and the process 100 can include controlling the at least one power control actuator based on the optical power.

### Photonic Device

In another embodiment, a photonic device 20 includes a Photonic Integrated Circuit (PIC) 24; and a laser 22 connected to an input of the PIC 24 via Polarization-maintaining (PM) devices 10; wherein the PM device 10 has a desired polarization axis on a first mode and undesired on a second undesired mode, and wherein the PIC 24 includes an on-chip first monitoring photodiode 38, 58 and circuitry configured to determine Polarization Extinction Ratio (PER) based on an optical power measured by the on-chip first monitoring photodiode 38, 58.

The on-chip first monitoring photodiode 38 can measure second undesired mode optical power and the PER is inferred based on the second undesired mode optical power. The photonic device 20 can further include a polarization combiner and rotator 36, i.e., a polarization splitter, connected to the input, wherein the first mode is connected to a first output of the polarization combiner and rotator 36 and the first monitoring photodiode 38 is connected to a second output of the polarization combiner and rotator 36. Note, the polarization combiner and rotator 36 can be referred to as a polarization splitter, as well as also referred to as a polarization rotator splitter (PRS) instead of a polarization combiner and rotator—note, these are essentially these same device, but used in the opposite direction, e.g., polarization combiner and rotator are used at chip output and PRS at chip input.

The photonic device 20 can further include a second monitoring photodiode 40 connected to the first output configured to monitor first mode optical power, wherein the PER is determined based on a comparison of the second undesired mode optical power and the first mode optical power. The photonic device 20 can further include a Spot Size Converter (SSC) 34 between the input and the polarization combiner and rotator 36. The PER cam ne determined by the first monitoring photodiode 38 via a direct measurement of the second undesired mode in steady-state condition.

The PIC 24 can include at least one power control actuator 56, the on-chip first monitoring photodiode 58 measures the optical power after the at least one power control actuator 58, and the at least one power control actuator 56 is controlled based on the optical power. The PER can be determined by the circuitry in a presence of a change in temperature, wavelength, and/or mechanical strain by monitoring a control response of the at least one power control actuator. The circuitry configured to determine the PER can be further configured to determine optical power fluctuations during temperature ramps, and determine the PER based on an amplitude and period of the optical power fluctuations.

The photonic device 20 can be an optical modem. The PM device 10 can be PM fiber. The first mode can be a Transverse Electric (TE) mode and the second undesired mode is a Transverse Magnetic (TM) mode.

### CONCLUSION

Those skilled in the art will recognize that the various embodiments may include processing circuitry of various types. The processing circuitry might include, but are not limited to, general-purpose microprocessors; Central Processing Units (CPUs); Digital Signal Processors (DSPs); specialized processors such as Network Processors (NPs) or Network Processing Units (NPUs), Graphics Processing Units (GPUs); Field Programmable Gate Arrays (FPGAs); or similar devices. The processing circuitry may operate under the control of unique program instructions stored in their memory (software and/or firmware) to execute, in combination with certain non-processor circuits, either a portion or the entirety of the functionalities described for the methods and/or systems herein. Alternatively, these functions might be executed by a state machine devoid of stored program instructions, or through one or more Application-Specific Integrated Circuits (ASICs), where each function or a combination of functions is realized through dedicated logic or circuit designs. Naturally, a hybrid approach combining these methodologies may be employed. For certain disclosed embodiments, a hardware device, possibly integrated with software, firmware, or both, might be denominated as circuitry, logic, or circuits “configured to” or “adapted to” execute a series of operations, steps, methods, processes, algorithms, functions, or techniques as described herein for various implementations.

Additionally, some embodiments may incorporate a non-transitory computer-readable storage medium that stores computer-readable instructions for programming any combination of a computer, server, appliance, device, module, processor, or circuit (collectively “system”), each potentially equipped with one or more processors. These instructions, when executed, enable the system to perform the functions as delineated and claimed in this document. Such non-transitory computer-readable storage mediums can include, but are not limited to, hard disks, optical storage devices, magnetic storage devices, Read-Only Memory (ROM), Programmable Read-Only Memory (PROM), Erasable Programmable Read-Only Memory (EPROM), Electrically Erasable Programmable Read-Only Memory (EEPROM), Flash memory, etc. The software, once stored on these mediums, includes executable instructions that, upon execution by one or more processors or any programmable circuitry, instruct the processor or circuitry to undertake a series of operations, steps, methods, processes, algorithms, functions, or techniques as detailed herein for the various embodiments.

While the present disclosure has been detailed and depicted through specific embodiments and examples, it is to be understood by those skilled in the art that numerous variations and modifications can perform equivalent functions or yield comparable results. Such alternative embodiments and variations, which may not be explicitly mentioned but achieve the objectives and adhere to the principles disclosed herein, fall within its spirit and scope. Accordingly, they are envisioned and encompassed by this disclosure, warranting protection under the claims associated herewith. That is, the present disclosure anticipates combinations and permutations of the described elements, operations, steps, methods, processes, algorithms, functions, techniques, modules, circuits, etc., in any manner conceivable, whether collectively, in subsets, or individually, further broadening the ambit of potential embodiments. Also, in the claims, the terms “comprise,” “comprises,” “comprising,” “include,” “includes,” and “including” are intended to be non-limiting and open-ended. These terms specifically list essential elements or steps but do not exclude additional elements or steps. This applies even when a claim or series of claims includes more than one of these terms.

What is claimed is:

1. A photonic device comprising:
a Photonic Integrated Circuit (PIC); and
a laser connected to an input of the PIC via a Polarization-maintaining (PM) device;
wherein the PM device has a desired polarization axis on a first mode and undesired on a second undesired mode, and wherein the PIC includes an on-chip first monitoring photodiode and circuitry configured to determine Polarization Extinction Ratio (PER) based on an optical power measured by the on-chip first monitoring photodiode.

2. The photonic device of claim 1, wherein the on-chip first monitoring photodiode measures second undesired mode optical power and the PER is inferred based on the second undesired mode optical power.

3. The photonic device of claim 2, further comprising
a polarization splitter connected to the input, wherein the first mode is connected to a first output of the polarization splitter and the first monitoring photodiode is connected to a second output of the polarization splitter.

4. The photonic device of claim 3, further comprising
a second monitoring photodiode connected to the first output configured to monitor first mode optical power, wherein the PER is determined based on a comparison of the second undesired mode optical power and the first mode optical power.

5. The photonic device of claim 3, further comprising
a Spot Size Converter (SSC) between the input and the polarization combiner and rotator.

6. The photonic device of claim 2, wherein the PER is determined by the first monitoring photodiode via a direct measurement of the second undesired mode in steady-state condition.

7. The photonic device of claim 1, wherein the PIC includes at least one power control actuator, the on-chip first monitoring photodiode measures the optical power after the at least one power control actuator, and the at least one power control actuator is controlled based on the optical power.

8. The photonic device of claim 7, wherein the PER is determined by the circuitry in a presence of a change in temperature, wavelength, and/or mechanical strain by monitoring a control response of the at least one power control actuator.

9. The photonic device of claim 8, wherein the circuitry configured to determine the PER is further configured to
determine optical power fluctuations during temperature ramps, and
determine the PER based on an amplitude and period of the optical power fluctuations.

10. The photonic device of claim 1, wherein the photonic device is an optical modem.

11. The photonic device of claim 1, wherein the PM device is PM fiber.

12. The photonic device of claim 1, wherein the first mode is a Transverse Electric (TE) mode and the second undesired mode is a Transverse Magnetic (TM) mode.

13. A method comprising steps of:
responsive to a laser being connected to an input of a Photonic Integrated Circuit (PIC) via a Polarization-maintaining (PM) device having a desired polarization axis on a first mode and undesired on a second undesired mode, monitoring optical power by an on-chip first monitoring photodiode; and
determining Polarization Extinction Ratio (PER) based on the monitored optical power.

14. The method of claim 13, wherein the on-chip first monitoring photodiode measures second undesired mode optical power and the PER is inferred based on the second undesired mode optical power.

15. The method of claim 14, wherein the steps further include
performing polarization splitting at the input via a polarization splitter, wherein the first mode is connected to a first output of the polarization splitter and the first monitoring photodiode is connected to a second output of the polarization splitter.

16. The method of claim 15, wherein the steps further include
measuring first mode optical power via a second monitoring photodiode connected to the first output, wherein the PER is determined based on a comparison of the first mode optical power and the second undesired mode optical power.

17. The method of claim 13, wherein the PER is determined by the first monitoring photodiode via a direct measurement of the second undesired mode in steady-state condition.

18. The method of claim 13, wherein the PER is determined by the first monitoring photodiode in a presence of a change in temperature, wavelength, and/or mechanical strain by monitoring a control response of power control actuators.

19. The method of claim 13, wherein the method is performed in an optical modem.

20. The method of claim 13, wherein the PIC includes at least one power control actuator, the on-chip first monitoring photodiode performs the monitoring the optical power after the at least one power control actuator, and wherein the steps further include controlling the at least one power control actuator based on the optical power.
